(19) United States
(12) Patent Application Publication
(10) Pub. No.: US 2011/0186199 A1
(43) Pub. Date: Aug. 4, 2011

(54) Pneumatic Tire

(75) Inventor: Tetsuji Miyazaki, Osaka (JP)

(73) Assignee: Toyo Tire & Rubber Co., Ltd., Osaka (JP)

(21) Appl. No.: 13/008,995

(22) Filed: Jan. 19, 2011

(30) Foreign Application Priority Data
Feb. 3, 2010 (JP) 2010-022375

(51) Int. Cl. B60C 11/12

(52) U.S. Cl. 152/209.18

(57) ABSTRACT

An object of the present invention is to provide a pneumatic tire that increases the on-ice performance while ensuring the on-dry road performance and the anti-abrasion performance without loosing advantages of radial sipes. In order to achieve the object, a pneumatic tire comprises a tread surface including a block formed with a plurality of radial sipes disposed radially, each of the radial sipes extends radially from a central area of the block and terminating in an edge area of the block, and the width of the sipes in the edge area of the block is larger than the width of the sipes in the central area of the block.

### BACKGROUND OF THE INVENTION

1. Field of the Invention

The present invention relates to a pneumatic tire having a tread pattern formed with a plurality of radial sipes that are radially disposed in tread blocks, particularly to a pneumatic tire usefully applicable to studless tires.

2. Description of the Related Art

Studless tires are formed with a plurality of cuts called as sipes in blocks thereon. Conventionally, utilizing water removal effect and edge effect of sipes, running performance of studless tires on iced road, which has low friction coefficient (hereinafter referred to as “on-ice performance”) has been improved. Water film, which is generated between the road and contact face of blocks of tire, is sucked by sipes utilizing the capillarity and is removed. Also, in order to increase the braking performance on iced road (hereinafter referred to as “on-ice braking performance”), a large number of sipes is disposed extending in a width direction of the tire to thereby increase the edge effect in the forward/backward direction. Further, in order to increase the turning performance on iced road (hereinafter referred to as “on-ice turning performance), the number of sipe elements having an angle close to a circumferential direction of the tire was increased to enhance edge effect in a lateral direction.

On the other hands, conventionally radial sipes, in which a plurality of sipes are disposed radially, are known as disclosed in, for example, Patent document 1 and Patent document 2. The radial sipes extend in all directions from a central area of a block. Therefore, the tire exerts the edge effect even in a case where a force acts on the tire in a lateral or oblique direction. As omnidirectional sipes, the radial sipes provide an advantage to improve not only the on-ice braking performance but also the on-ice turning performance.

However, when the radial sipes are disposed in the block, the sipes are disposed densely at the inner side in a central area of the block; thus the stiffness tends to be decreased in the central area of the block. Contrarily, in the outer edge area in the block, the distance between the sipes become larger and the sipes are disposed sparsely. As a result, the stiffness of the block tends to be increased in the edge area of the block. In the radial sipes disclosed in Patent document 1 and Patent document 2, in order to reduce the difference in stiffness between the central area of the block and the edge area of the block as well as to enhance the water removal effect of the sipes, the radial sipes are arranged to open to grooves or shoulder end portion in the edge area of the block. However, in this case, the stiffness tends to be excessively decreased in the edge area of the block. As a result, with such a constitution, the running performance on dry road (hereinafter referred to as “on-dry road performance”) and anti-abrasion performance tend to be decreased due to the stiffness decreased in the edge area of the block.

As described above, conventionally, it was extremely difficult to increase the on-ice performance while ensuring the on-dry road performance and the anti-abrasion performance.
Patent document 1: Japanese Unexamined Patent Publications No. 2000-289413
Patent document 2: Japanese Unexamined Patent Publications No. 2001-277817

### SUMMARY OF THE INVENTION

In view of the above circumstances, the present invention has been made and an object thereof is to provide a pneumatic tire that increases the on-ice performance while ensuring the on-dry road performance and the anti-abrasion performance without loosing advantages of radial sipes.

The above object can be achieved by the present invention described below. That is, the pneumatic tire according to the present invention comprises a tread surface including a block formed with a plurality of radial sipes disposed radially, wherein each of the radial sipes extends radially from a central area of the block and terminating in an edge area of the block, and the width of the sipes in the edge area of the block is larger than the width of the sipes in the central area of the block.

In the pneumatic tire according to the present invention, the width of the radial sipes in the edge area of the block is larger than the width of the sipes in the central area of the block. Therefore, an appropriate bending of the block is ensured in the edge area of the block. As a result, the road-hugging property of the block is improved in the edge area of the block having a wider distance between the sipes. Moreover, the width of the radial sipes in the edge area of the block is larger than the width of the sipes in the central area of the block. Therefore, the removal efficiency of water film generated between iced road and the block contact face is enhanced effectively in the edge area of the block. As a result, in the pneumatic tire according to the present invention, the on-ice performance is improved.

Since radial sipes extend radially from the central area of the block and terminate in the edge area of the block, the stiffness of the block is prevented from deterioration even when the width of the sipe in the edge area of the block is set largely. Generally, on dry road having a large friction coefficient, contact pressure in the edge area of the block tends to become larger. However, in the pneumatic tire according to the present invention, the stiffness of the block in the edge area of the block is ensured. Therefore, during running on dry road, the block is prevented from being bent excessively. As a result, in the pneumatic tire according to the present invention, the on-dry road performance is improved as well as the anti-abrasion performance is improved.

In the present specification, the density of disposed sipes depends on the ratio of the sipe length relative to a unit area of the block.

In the above pneumatic tire, each of the radial sipes preferably includes three or more portions each having a different width. With such a constitution, even in a case where a sipe portion having a minimal width of the sipe is closed with respect to the road due to a deformation of the block, the sipe portion having larger width is effectively prevented from being closed. As a result, the removal efficiency of water film is exerted more effectively while suppressing the road-hugging property of the block from being decreased; thereby the on-ice performance is particularly improved.

In the above pneumatic tire, in addition to the radial sipes, a separation sipe separating the block into two portions is preferably formed so as to open to the edge areas of the block. In addition to the radial sipes, for example, when the separation sipe is formed being extended in the width direction of the tire, the on-ice braking performance is further improved. When the sipe extending in the circumferential direction of the tire is formed, the on-ice turning performance is further improved.

### BRIEF DESCRIPTION OF THE DRAWINGS

FIG. 1 is a development view showing an example of a tread of a pneumatic tire according to the present invention;

FIG. 2 is an enlarged view of a block formed on the tread of FIG. 1;

FIG. 3 shows a modification of the block;

FIG. 4 shows a modification of the block;

FIG. 5 shows a modification of the block; and

FIG. 6 is a plan view of a block in Comparative Example 1.

### DETAILED DESCRIPTION OF THE PREFERRED EMBODIMENTS

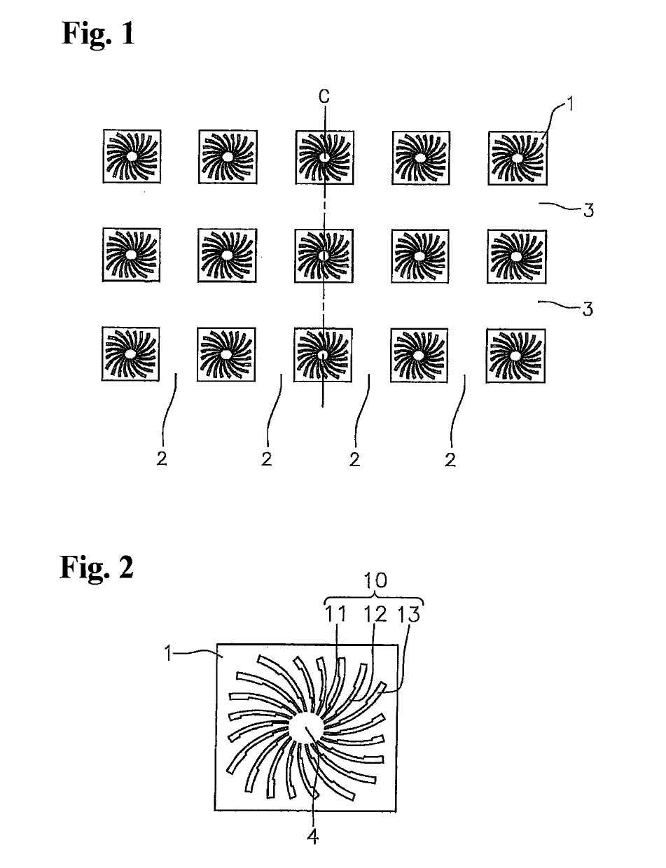

Embodiments of the present invention will be described below with reference to the accompanying drawings. FIG. 1 is a development view showing an example of a tread of a pneumatic tire according to the present invention. FIG. 2 is an enlarged view of a block 1 provided to the tread of FIG. 1.

As shown in FIG. 1, the pneumatic tire includes a tread surface that has a tread pattern formed with a plurality of radial sipes 10 radially disposed on the block 1. The present embodiment shows an example in which each of the blocks 1 is partitioned by main grooves 2 extending in a circumferential direction of the tire and lateral grooves 3 extending laterally crossing the main grooves 2, and the blocks are arranged in 5 rows symmetrically with respect to an equatorial line C of the tire.

As shown being enlarged in FIG. 2, each of the radial sipes 10 formed in the block 1 is configured in a shape such that the width of the sipe increases from a central area toward the edge area of the block 1. With such a constitution, since appropriate bent of the block 1 is ensured in the edge area thereof, the road-hugging property of the block 1 is improved in the edge area of the block 1. Further, since the width of the sipe in the edge area of the block 1 of the radial sipes 10 is larger than the width of the sipe in the central area of the block 1, in the edge area of the block 1, the efficiency of removing water film which is generated between iced road and contact face of the block is effectively enhanced. Due to the improved road-hugging property and the water film removal efficiency, the on-ice performance of the pneumatic tire is improved.

Particularly in the present embodiment, each of the radial sipes 10 is constituted of three portions; that is, a first sipe portion 11 that is located in the central area of the block 1 and has a smallest width of the sipe, a second sipe portion 12 that is located at the outer side of the first sipe portion 11 and has a width of the sipe larger than that of the first sipe portion 11, and a third sipe portion 13 that is located in the edge area of the block 1 and has a largest width of the sipe. With such a constitution, even when the first sipe portion 11 that has the smallest width of the sipe is closed with respect to the road due to a deformation of the block, the second sipe portion 12 and/or the third sipe portion 13 having a larger width of the sipe is/are suppressed from being closed. As a result, while suppressing the road-hugging property of the block 1 from decreasing, since the removal efficiency of water film is exerted more effectively, the on-ice performance is particularly improved. In such a case, the width of the sipe of the first sipe portion 11 is, for example, 0.2 to 0.7 mm; the width of the sipe of the second sipe portion 12 is, for example, 0.5 to 1.1 mm; and the width of the sipe of the third sipe portion 13 is, for example, 0.8 to 1.5 mm. Also, the depth of the sipe of the radial sipe 10 is, for example, 3 to 12 mm.

Each of the radial sipes 10 extends radially from the central area of the block 1 and is terminated in the edge area of the block 1. In this case, even when the width of the sipe in the edge area of the block 1 is arranged to be large, the stiffness of the block is prevented from decreasing. As a result, the on-dry road performance and the anti-abrasion performance of the pneumatic tire are improved.

In the present embodiment, each of the radial sipes 10 extends from the centre of the block 1 at intervals without crossing each other (as shown in FIG. 2). Accordingly, the block 1 includes a no sipe portion 4 provided in a generally central area thereof. In conventional radial sipes, in an area closer to the center of the block, generally sipes are disposed densely. Accordingly, the block tends to largely decrease the stiffness thereof in the central area of the block. However, by providing the no sipe portion 4 in the central area of the block 1, not only the stiffness of the block is ensured in the central area of the block 1 but also the contact area of the block 1 is ensured; and thus, the on-ice performance is further improved. Note that the wording “central area” on the block surface means a position on the block surface equivalent to a center of gravity in a three-dimensional object (center of two-dimensional plane).

The pneumatic tire of the present invention is the same as conventional pneumatic tires, except that above radial sipes are formed in the blocks on the tread surface. Therefore, any of the conventionally known materials, forms, structures, manufacturing methods and the like are applicable to the present invention. The blocks in the tread are not limited to the blocks which are completely enclosed by grooves. The present invention can be applied thereto, as long as blocks are formed as substantially blocks in a manner such that a part of blocks is connected to neighboring blocks being arranged in a circumferential direction of the tire.

The present invention may be applied to so-called summer tires. However, since the tire of the present invention is superior in running performance on iced road, the present invention is effectively applicable particularly to studless tires (winter tires).

### Other Embodiments

(1) The tread pattern formed on the pneumatic tire of the present invention is not limited to the above pattern but various patterns may be employed. Also, the shape of the block on which radial sipes are formed is not limited to a rectangular shape but other shapes such as a polygonal or circular shape may be employed. Particularly when the block is formed in a circular shape, the edge elements in block edge area are arranged in all directions. Therefore, combined with the edge effect by the radial sipes, the on-ice performance is improved in all directions.

(2) In the above embodiment, the radial sipes 10 extend in a curved shape. The present invention is not limited to that, but these sipes may extend linearly, in an L-like shape, a wave-like shape or a zigzag shape. Compared to linear sipes, curved sipes provide a larger number of edge elements. Further, compared to an L-like shape, a wave-like shape or a zigzag shape, curved sipe provides an advantage such that intervals of the sipes can be easily adjusted.

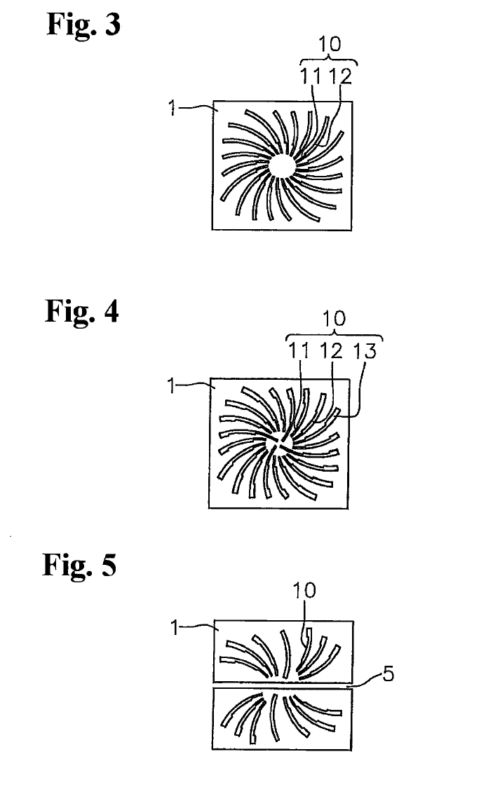

(3) In the above embodiment, the radial sipes 10 are constituted of three different widths. However, in the present invention, each of the radial sipes 10 may be constituted of a first sipe portion 11, which is located at the central area of the block 1 and the thickness of the sipes is the smallest, and a second sipe portion 12, which is located at the outer side thereof and the width of the sipe is larger than that of the first sipe portion 11 as shown in FIG. 3. Even when the sipes are constituted of two portions having a width different from each other, since the width of the sipes in the edge area of the block 1 is larger than the width of the sipe in the central area of the block 1, the on-ice performance of the pneumatic tire is improved. In the present invention, the width of the sipes may be continuously increased smoothly from the central area of the block 1 to the edge area of the block 1 (not shown).

(4) In the above embodiment, an example in which the no sipe portion 4 is provided in the central area of the block 1 is given. However, in the present invention, at least one (four in FIG. 4) of the sipes constituting the radial sipes 10 may extend to the adjacent to the center of the block 1 as shown in FIG. 4. With such a constitution, the stiffness of the block 1 in the central area thereof is appropriately decreased and bending of the block 1 is ensured appropriately; and thus the road-hugging property in the central area of the block 1 is improved.

(5) In the above embodiment, an example in which only the radial sipes 10 are formed in the block 1 is given. However, in the present invention, in addition to the radial sipes 10, a separation sipe 5 that opens to the edges of the block 1 and separates the block 1 into two parts may be formed in the block 1 as shown in FIG. 5. The separation sipe 5 may extend in a width direction of the tire as shown in FIG. 5 or in a circumferential direction of the tire (not shown). By employing the separation sipe extends in the width direction of the tire, the on-ice braking performance is further improved. By employing the separation sipe extending in a circumferential direction of the tire, the on-ice turning performance is further improved.

### EXAMPLES

Examples for demonstrating specifically the structure and the effects of the present invention will be described below. The performance of the test tires was evaluated as described below.

(1) On-Ice Braking Performance (on-Ice Performance Upon Braking)

Test tires were mounted to an actual vehicle (1,500 cc, 4WD sedan), and, while running at a speed of 40 Km/h on an iced road, braking force was applied to activate ABS. Evaluation was made using an inverse number of the braking distance. Defining the value of Comparative Example 1 as 100, the test result was evaluated by using an index. The larger the numerical value, the more the on-ice braking performance is excellent.

(2) On-Ice Turning Performance (on-Ice Performance During Turning)

Test tires were mounted to an actual vehicle (1,500 cc, 4WD sedan), and while turning (J-turn) at a speed of 20 Km/h on an iced road, the force in a lateral direction was measured. Defining the value of Comparative Example 1 as 100, the test result was evaluated using an index. The larger the numerical value, the more the lateral force is large and the on-ice turning performance is excellent.

(3) Anti-Abrasion Performance

Test tires were mounted to an actual vehicle (1,500 cc, 4WD sedan), and after having run 10,000 Km on an ordinary road, the worn volume was measured by comparing the main groove of the test tire and a virgin tire. Defining the inverse number of the worn volume of Comparative Example 1 as 100, the test result was evaluated. The larger the numerical value, the more the anti-abrasion performance is excellent.

(4) On-Dry Road Performance

Test tires were mounted to an actual vehicle (1,500 cc, 4WD sedan), while running on a dry road, sensory evaluation on steering stability was made by a driver on a scale of one to ten. Defining the inverse number of wear volume of Comparative Example 1 as 100, the test result was evaluated. The larger the numerical value, the more the on-dry road performance is excellent.

### Comparative Example 1

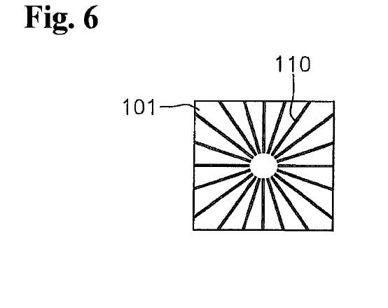

A pneumatic tire (195/65R15) equipped with a block 101 shown in FIG. 6 in place of the block 1 on the tread pattern shown in FIG. 1 was prepared. The block 101 was formed with the radial sipes 110 constituted of linear sipes and opened to edge areas of the block 101. The depth of the grooves 2 and 3 in the tread pattern was set to 8.7 mm, and the depth of the sipe was set to 6.3 mm. The test results are shown in Table 1.

### Example 1

A pneumatic tire with the same constitution as in Comparative Example 1, except that the block 1 was formed with the radial sipes 10 shown in FIG. 2 (the width of the sipe of the first sipe portion 11 was 0.35 mm, the width of the sipe of the second sipe portion 12 was 0.7 mm, and the width of the sipe of the third sipe portion 13 was 1.0 mm) in the tread pattern shown in FIG. 1, was prepared. The test results are shown in Table 1.

### Example 2

A pneumatic tire with the same constitution as in Comparative Example 1, except that the block 1 was formed with the radial sipes 10 shown in FIG. 3 (the width of the sipe of the first sipe portion 11 was 0.35 mm, and the width of the sipe of the second sipe portion 12 was 0.7 mm) in the tread pattern shown in FIG. 1, was prepared. The test result is shown in Table 1.

### Example 3

A pneumatic tire with the same structure as in comparative Example 1, except that the block 1 was formed with the radial sipes 10 shown in FIG. 4 (the width of the sipe of the first sipe portion 11 was 0.35 mm, the width of the sipe of the second sipe portion 12 was 0.7 mm, and width of the sipe of the third sipe portion 13 was 1.0 mm) in the tread pattern shown in FIG. 1, was prepared. The test results are shown in Table 1.

TABLE 1

| | | Comparative | Exam- | | Exam- |
|---|---|---|---|---|---|
| | | Example 1 | ple 1 | Example 2 | ple 3 |
| On-ice | On-ice | 100 | 109 | 112 | 113 |
| performance | braking | | | | |
| | performance | | | | |
| | On-ice | 100 | 109 | 112 | 113 |
| | turning | | | | |
| | performance | | | | |

| | | | | |
|---|---|---|---|---|
| Anti-abrasion | 100 | 110 | 108 | 107 |
| performance | | | | |
| On-dry road performance | 100 | 107 | 105 | 107 |

As is apparent from Table 1, as compared with the pneumatic tire of Comparative Example 1, in the pneumatic tires of Examples 1 to 3, while the on-ice performance is improved, the on-dry road performance and the anti-abrasion performance are improved.

What is claimed is:

1. A pneumatic tire, comprising a tread surface including a block formed with a plurality of radial sipes disposed radially, wherein
each of the radial sipes extends radially from a central area of the block and terminating in an edge area of the block, and
the width of the sipes in the edge area of the block is larger than the width of the sipes in the central area of the block.

2. The pneumatic tire according to claim 1, wherein each of the radial sipes includes three or more portions each having different width.

3. The pneumatic tire according to claim 1, wherein, in addition to the radial sipes, a separation sipe separating the block into two portions is formed so as to open to the edge areas of the block.
